(19) United States
(12) Patent Application Publication
(10) Pub. No.: US 2004/0098549 A1
(43) Pub. Date: May 20, 2004

(54) Apparatus and methods for programmable interfaces in memory controllers

(76) Inventor: Jeffrey R. Dorst, Austin, TX (US)

Correspondence Address: Maximilian R. Peterson, O'KEEFE, EGAN & PETERMAN, Building C, Suite 200, 1101 Capital of Texas Highway South, Austin, TX, 78746, US

(21) Appl. No.: 09/971,197

(22) Filed: Oct. 4, 2001

(51) Int. Cl. G06F 12/00

(52) U.S. Cl. 711/167

(57) ABSTRACT

A memory controller includes a register and an interface circuitry. The register stores read timing-parameters for a memory. The interface circuitry communicates with the memory by providing a plurality of control signals to the memory. The control signals may include a chip-enable signal and a read-enable signal. The interface circuitry uses the read timing-parameters to provide the plurality of control signals. The relative timing of the plurality of control signals to one another depends at least in part on the read timing-parameters. The user can program the read timing-parameters in order to support and facilitate transactions with a variety of memory devices.

### CROSS-REFERENCE TO RELATED APPLICATIONS

The present patent application relates to concurrently filed, commonly owned U.S. patent application Ser. No. ______, Attorney Docket No. ZILG524, titled “Apparatus and Methods for Dedicated Command Port in Memory Controllers.” The present patent application incorporates by reference the above patent application.

### TECHNICAL FIELD OF THE INVENTION

The invention relates to data processing system and, more particularly, the invention concerns apparatus and methods for programmable interfaces in memory controllers.

### BACKGROUND

Present-day data-processing applications perform increasingly complex operations on progressively larger amounts of data. Handling the large amount of data has resulted in memory circuits with increased sophistication and capacity. To reduce the burden and overhead on the processor or processors of interfacing with and controlling the memory, data-processing systems typically include one or more memory controllers.

To address various data storage and retrieval needs, data-processing systems usually include more than one type of memory. Some of the memories use a random-access-memory (RAM) interface. Other memories incorporate a chip-select interface (CSI) or chip-enable interface, a typically asynchronous interface that includes address signals, read and/or write enable signals, and a chip-select or chip-enable signal. Each of those types of memory typically has its own operational specifications which, among other things, include timing specifications. Controlling those memory circuits entails providing timing and control signals that meet each manufacturer's and each particular part's specifications. Furthermore, future memories may include different timing and control signals than the memories in use presently.

To accommodate the diversity of memory-circuit timing and control specifications, conventional memory controllers have used one of two approaches. Some memory controllers include simple means that enable the user to specify certain timing aspects of the memory circuitry, for example, the tenure of the address signals that the controller provides to the memory. Those memory controllers fail to provide a flexible interface that allows the user to control the diverse types of memory in data-processing systems.

Other memory controllers use an approach that essentially allows the user to specify the waveforms that the controller provides to a memory on a clock-cycle or even sub-clock-cycle basis. Typically, this type of controller uses relatively large amounts of memory within the controller to store data or sample points for each of the waveforms that the controller provides to a memory. Consequently, these controllers are relatively complex. To use them, the user has to provide a relatively large number of data points. Thus, these controllers tend to be cumbersome and difficult to use. A need exists for a flexible to use memory controller that can control a multitude of memory circuits in a simple-to-use manner.

### SUMMARY OF THE INVENTION

This invention contemplates apparatus and methods for programmable memory controllers. The invention relates to memory controllers that control memories with chip-select-type interfaces (as distinguished from random-access-memory type of interfaces). Memory controllers according to the invention provide a relatively simple-to-use, flexible solution that allows the user to program the relative timing of address and control signals for chip-select-type memories.

One aspect of the invention concerns apparatus for controlling chip-select-type memories. In one embodiment, a memory controller includes a register and an interface circuitry. The register stores read timing-parameters for a memory. The interface circuitry communicates with the memory by providing a plurality of control signals to the memory. The interface circuitry uses the read timing-parameters to provide the plurality of control signals to the memory. The relative timing of the plurality of control signals to one another depends at least in part on the read timing-parameters.

In a second embodiment, a memory controller includes a plurality of register sets and an interface circuitry. Each register set in the plurality of register sets stores read timing-parameters and write timing-parameters for interfacing with one of a plurality of memory types. The interface circuitry communicates with the plurality of memory types by providing a plurality of control signals. The interface circuitry uses the read and write timing parameters to provide the plurality of control signals, such that the relative timing of the plurality of control signals to one another depends at least in part on the read and write timing-parameters.

In a third embodiment, a data-processing system includes a processor, at least one memory, and a memory controller. The processor receives, decodes, and executes user-program instructions. The memory (or memories) stores and retrieves data and instructions. The memory controller couples to the processor and to the memory (or memories), and provides communication between the processor and the memory (or memories). The memory controller communicates with the at least one memory by using a plurality of signals, where the plurality of signals have a pre-determined relative timing relationship to one another. The relative timing relationship of the control signals depends, at least in part, on a set of configurable parameters that the user may program.

Another aspect of the invention relates to methods of interfacing with, or controlling, chip-select-interface memories. In one embodiment, a method according to the invention of interfacing with a memory includes storing in a register a set of read timing-parameters for the memory, using the read timing-parameters to provide a plurality of signals, and communicating the plurality of signals to the memory. The relative timing of the plurality of signals to one another depends, at least in part, on the read timing-parameters.

In a second embodiment, a method according to the invention of communicating with a plurality of memory types includes storing in each of a plurality of register sets read timing-parameters and write timing-parameters for a selected one of the plurality of memory types. The method further includes using the read and write timing-parameters for a selected one of the plurality of memory types to provide a plurality of signals, and communicating the plurality of signals to the selected one of the plurality of memory types. The relative timing of the plurality of signals to one another depends, at least in part, on the read and write timing-parameters.

### DESCRIPTION OF THE DRAWINGS

The appended drawings illustrate only exemplary embodiments of the invention and should not be construed to limit its scope. The disclosed inventive concepts lend themselves to other equally effective embodiments. In the drawings, the same numerals used in more than one drawing denote the same, similar, or equivalent functionality, components, or blocks.

FIG. 1 shows a conceptual block diagram of a data-processing system that includes a memory controller according to the invention.

FIG. 2 illustrates a conceptual block diagram of another data-processing system that includes a memory controller according to the invention.

FIG. 3 depicts a conceptual block diagram of another system that includes a memory controller according to the invention.

FIG. 4 shows a conceptual block diagram that shows more details of a memory controller according to the invention.

FIG. 5 illustrates more conceptual block diagram details of the programmable registers within the memory controller.

FIG. 6 depicts more details of various control signals in exemplary embodiments of the invention.

FIG. 7 shows the fields within one of the register sets in an exemplary embodiment of the invention.

FIG. 8 shows an exemplary timing for a single beat read transaction in an exemplary embodiment of the invention.

FIG. 9 depicts an exemplary timing for a chip-select-interface (CSI) single-beat write transaction in an exemplary embodiment of the invention.

FIG. 10 illustrates an exemplary timing for a 4-beat CSI burst read transaction, with read burst-wait disabled, in an exemplary embodiment of the invention.

FIG. 11 shows an exemplary timing for a 4-beat CSI burst read transaction, with read burst-wait enabled, in an exemplary embodiment of the invention.

FIG. 12 depicts an exemplary timing in an exemplary embodiment of the invention for a read transaction where an external device determines the read access latency via the external ready signal.

FIG. 13 illustrates an exemplary timing in an exemplary embodiment of the invention for a write transaction where an external device determines the write access latency via the external ready signal.

### DETAILED DESCRIPTION OF THE INVENTION

This invention contemplates apparatus and methods for programmable memory controllers. More particularly, the invention relates to programmable chip-select-type interfaces in memory controllers. Memory controllers according to the invention provide a relatively simple-to-use, flexible solution to the problems encountered in conventional memory controllers. By programming a relatively few parameters, a user can control a variety of memory types. Memory controllers according to the invention allow the user to specify and control the relative timing of the control signals to one-another, as well as the relative timing of the address signals and the control signals.

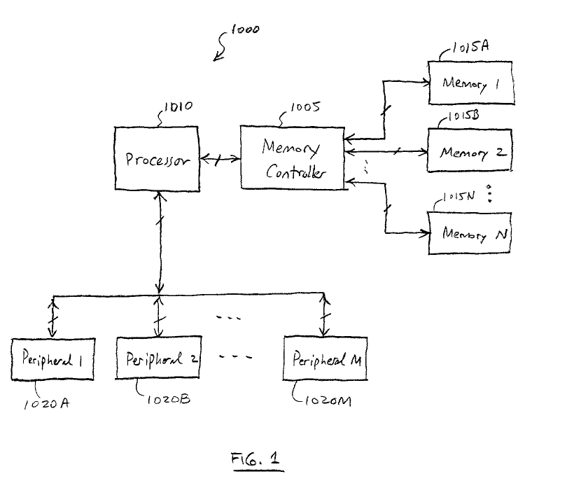

FIG. 1 shows a conceptual block diagram of a data-processing system 1000 that includes a memory controller 1005 according to the invention. The data-processing system 1000 also includes a processor 1010. Depending on its specifications and a particular implementation, the system 1000 may have more than one processor 1010 and/or more than one memory controller 1005, as desired. The processor 1000 receives, decodes, and executes program instructions. The program instructions may operate on data within the system 1000 and/or external data.

One or more memories 1015A-1015N store program instructions and data. Generally, the memories 1015A-1015N may include a wide variety of memories, such as read-only memories (ROM), random-access memories (RAM), static random-access memories (SRAM), dynamic random-access memories (DRAM), synchronous dynamic random-access memories (SDRAM), flash memories, programmable read-only memories (PROM), erasable programmable read-only memories (EPROM), electrically erasable read-only memories (EEROM), and electrically erasable programmable read-only memories (EEPROM). The memory controller 1005 couples to, and communicates with, the memories 1015A-1015N. The memory controller 1005 may also communicate with the processor 1010, either directly, or through an interface circuitry (not shown).

The system 1000 may optionally include one or more peripherals 1020A-1020M, as desired. The peripherals 1020A-1020M may include a variety of devices, for example, communication or telecommunication circuitry, video circuitry, audio circuitry, input circuitry, output circuitry, storage circuitry, and network circuitry. The system 1000 may also include one or more interface circuitries (not shown explicitly) that interface one or more of the peripherals 1020A-1020M to the processor circuitry 1010. Note that at least some of the peripherals 1020A-1020M and/or interface circuitries (not shown) may reside within the processor 1010, as desired. Note also that one may integrate one or more blocks of the system 1000 in one ore more integrated circuits, as desired.

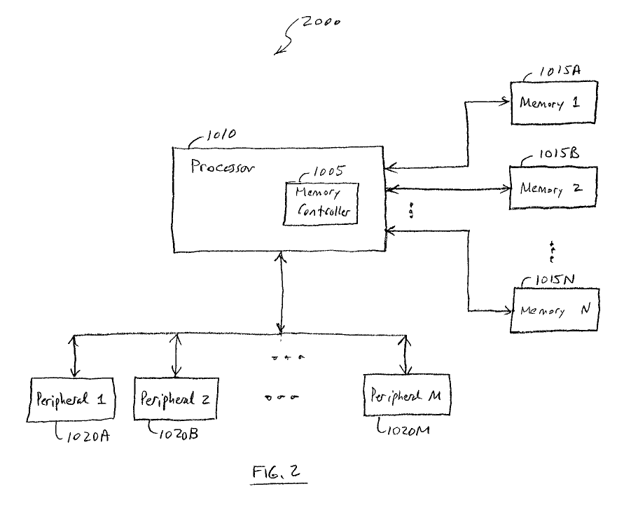

FIG. 2 illustrates a conceptual block diagram of another data-processing system 2000 that includes a memory controller 1005 according to the invention. The memory controller resides within a processor 1010. The processor 1010 receives, decodes, and executes program instructions. The program instructions may operate on data within the system 2000 and/or external data. Depending on its specifications and a particular implementation, the system 1000 may have more than one processor 1010 and/or more than one memory controller 1005, as desired. Furthermore, several processors 1010 may share a memory controller 1005, or vice-versa, depending on the application and desired performance, as persons of ordinary skill in the art would understand.

One or more memories 1015A-1015N store program instructions and data. Generally, the memories 1015A-1015N may include a wide variety of memories, such as read-only memories (ROM), random-access memories (RAM), static random-access memories (SRAM), dynamic random-access memories (DRAM), synchronous dynamic random-access memories (SDRAM), flash memories, programmable read-only memories (PROM), erasable programmable read-only memories (EPROM), electrically erasable read-only memories (EEROM), and electrically erasable programmable read-only memories (EEPROM). The memory controller 1005 couples to, and communicates with, the memories 1015A-1015N.

The system 2000 may optionally include one or more peripherals 1020A-1020M, as desired. The peripherals 1020A-1020M may include a variety of devices, for example, communication or telecommunication circuitry, video circuitry, audio circuitry, input circuitry, output circuitry, storage circuitry, and network circuitry. The system 2000 may also include one or more interface circuitries (not shown explicitly) that interface one or more of the peripherals 1020A-1020M to the processor circuitry 1010. Note that at least some of the peripherals 1020A-1020A-1020M and/or interface circuitries (not shown) may reside within the processor 1010, as desired.

Note that one may integrate one or more blocks of the system 2000 in one ore more integrated circuits, as desired. For example, in exemplary embodiments of the invention, the processor 1010 and the memory controller 1005 reside within a single integrated circuit. The choice of integration and partitioning of the system 2000 depends on design criteria and specification, as persons skilled in the art would understand.

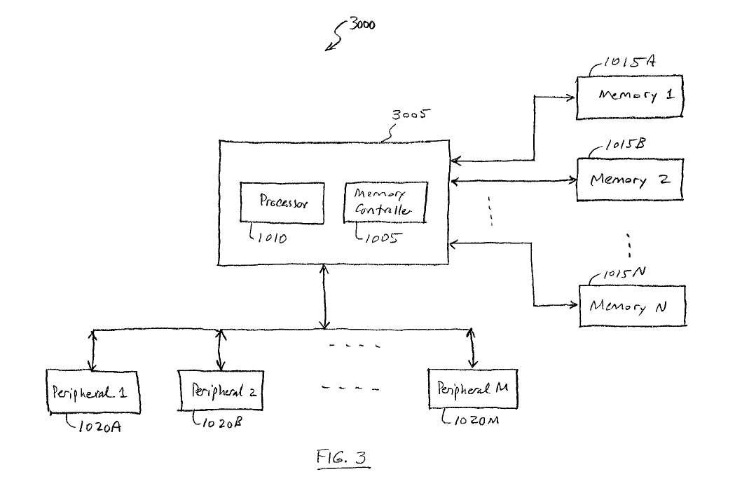

FIG. 3 depicts a conceptual block diagram of another system 3000 that includes a memory controller 1005 according to the invention. The system 3000 also includes a processor 1010. The processor 1010 receives, decodes, and executes program instructions. The program instructions may operate on data within the system 3000 and/or external data. Depending on its specifications and a particular implementation, the system 1000 may have more than one processor 1010 and/or more than one memory controller 1005, as desired. Furthermore, several processors 1010 may share a memory controller 1005, or vice-versa, depending on the application and desired performance, as persons of ordinary skill in the art would understand.

The system 3000 includes a data-processing block 3005. In the exemplary embodiment shown in FIG. 3, the processor 1010 and the memory controller 1005 reside within the data-processing block 3005. The data processing block 3005 may constitute an integrated circuit, a multi-chip module, or an electronic assembly, such as a printed-circuit assembly, that includes data-processing elements and circuitries. Functionally, the data-processing block 3005 may constitute a single processing element, such as a single-processor computer, or a node in a multiprocessor system (not shown), or a node in a network of interconnected or distributed processors (not shown).

One or more memories 1015A-1015N store program instructions and data. Generally, the memories 1015A-1015N may include a wide variety of memories, such as read-only memories (ROM), random-access memories (RAM), static random-access memories (SRAM), dynamic random-access memories (DRAM), synchronous dynamic random-access memories (SDRAM), flash memories, programmable read-only memories (PROM), erasable programmable read-only memories (EPROM), electrically erasable read-only memories (EEROM), and electrically erasable programmable read-only memories (EEPROM). The memory controller 1005 couples to, and communicates with, the memories 1015A-1015N. The memory controller 1005 may also communicate with the processor 1010, either directly, or through interface circuitry (not shown).

The system 3000 may optionally include one or more peripherals 1020A-1020M, as desired. The peripherals 1020A-1020M may include a variety of devices, for example, communication or telecommunication circuitry, video circuitry, audio circuitry, input circuitry, output circuitry, storage circuitry, and network circuitry. The system 3000 may also include one or more interface circuitries (not shown explicitly) that interface one or more of the peripherals 1020A-1020M to the processor circuitry 1010. Note that at least some of the peripherals 1020A-1020M and/or interface circuitries (not shown) may reside within the processor 1010, as desired.

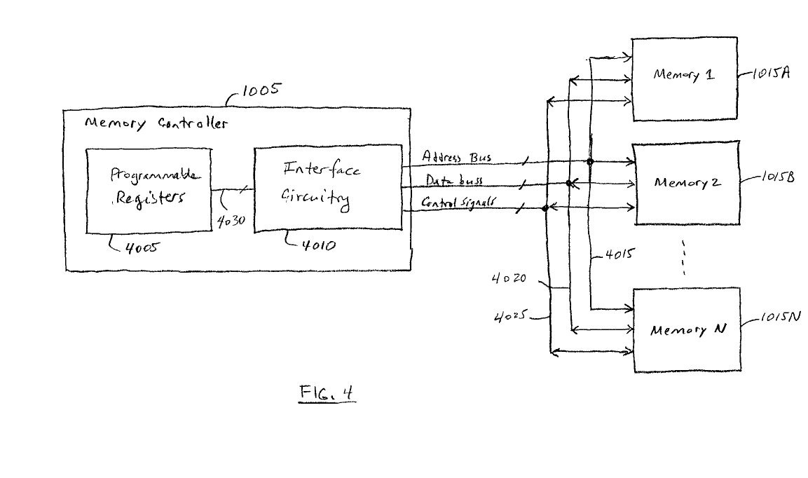

FIG. 4 shows a conceptual block diagram that shows more details of a memory controller 1005 according to the invention. The memory controller 1005 includes programmable registers 4005 and interface circuitry 4010. In exemplary embodiments of the invention, the programmable registers 4005 store read timing-parameters and write timing-parameters for memories 1015A-1015N, as described below in more detail. In other embodiments, the programmable registers 4005 store read timing-parameters for memories 1015A-1015N. Programmable registers 4005 provide a plurality of signals 4030 to interface circuitry 4010. Signals 4030 derive from, correspond to, or represent, one or more of the read timing-parameters and/or write timing-parameters. Interface circuitry 4010 uses signals 4030 to communicate with, and control, memories 1015A-1015N.

Interface circuitry 4010 communicates with memories 1015A-1015N through an address bus 4015, a data bus 4020, and a set of control signals 4025. Address bus 4015 provides address signals to one or more of memories 1015A-1015N. During a read operation, the addressed memory or memories 1015A-1015N retrieve data at the respective address and makes it available through data bus 4020. During a write operation, memory controller 1005 provides data that the addressed memory or memories 1015A-1015N store at the respective address.

The role of the control signals 4025 depends on the type of memory 1015A-1015N with which the memory controller 1005 seeks to communicate. Some devices, such as RAM devices, use an interface protocol that includes signals known as row-address strobe (RAS), column-address strobe (CAS), and the like. Other devices use a chip-select interface (CSI). Some of the memories 1015A-1015N may constitute CSI devices. Memory controllers according to the invention provide programmable control of CSI devices, as described below in more detail.

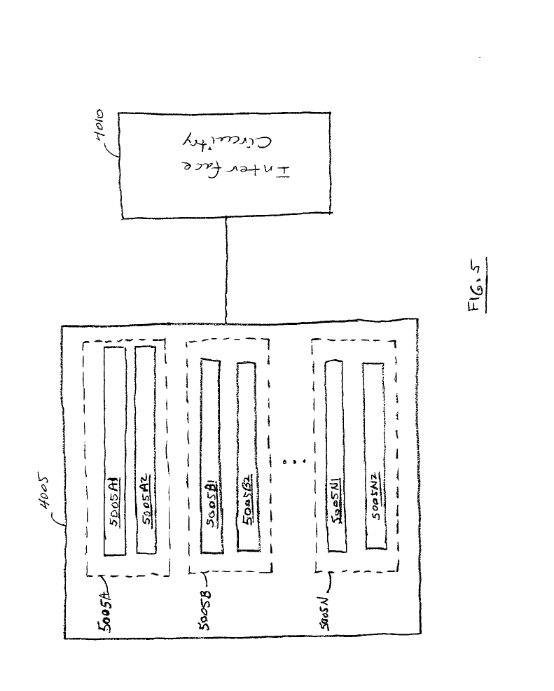

FIG. 5 illustrates more conceptual block diagram details of the programmable registers 4005 within the memory controller 1005. The programmable registers sets 4005 include a plurality of register sets 5005A-5005N. In exemplary embodiments, each of register set 5005A-5005N corresponds to a respective one of memories 1015A-1015N. In other words, the number of register sets 5005A-5005N equals the number of memories 1015A-1015N. In other exemplary embodiments, one may use a given register set 5005A-5005N to control more than one memory 1015A-1015N, as desired. Furthermore, rather than using separate registers 5005A-5005N, one may use a single register, as desired. In that situation, the register may have several fields within it, where the fields map to various memories 1015A-1015N.

Each register set 5005A-5005N includes a read timing-parameter register 5005A-15005N1. The read timing-parameter registers 5005A1-5005N1 store timing parameters for read operations from memories 1015A-1015N. Each register set 5005A-5005N may also include a write timing-parameter register 5005A2-5005N2. The write timing-parameter registers 5005A2-5005N2 store timing parameters for write operations to memories 1015A-1015N. One may combine into a single register (with respective fields) each of the read timing parameter registers 5005A1-5005N1 with a respective write timing-parameter register 5005A2-5005N2 for each of the memories 1015A-1015N, as desired. In other words, one may use a single register, with respective fields for memories 1015A-1015N, where each field in turn includes a field for read timing-parameters, and may also include a field for write timing-parameters.

Note that in some data-processing systems, the memories 1015A-1015N may constitute read-only memories. In those circumstances, one may use a memory controller according to the invention that includes only registers for read timing-parameters. In other words, if the data-processing system does not write to any of the memories 1015A-1015N, one may choose to not include in the memory controller 1005 write timing-parameter registers 5005A2-5005N2.

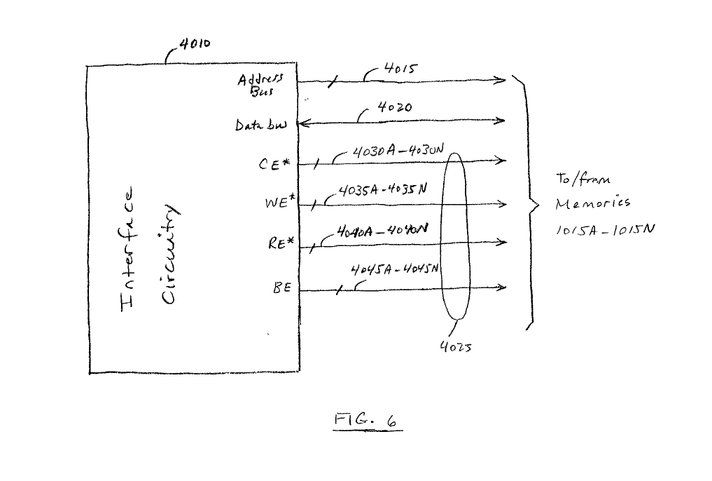

FIG. 6 depicts more details of control signals 4025 in exemplary embodiments of the invention. An asterisk (*) after a signal name denotes an active-low logic signal, although persons skilled in the art will recognize that one may use active-high logic signals or a combination of the two types of signal, as desired. The control signals 4025 shown in FIG. 6 correspond to memories 1015A-1015N that constitute CSI devices. As persons of ordinary skill in the art would understand, however, one may include other signals as control signals 4025, as desired. For example, if memories 1015A-1015N include RAM devices, control signals 4025 may include appropriate signals (such as RAS and CAS) to accommodate a suitable interface for those devices. Thus, memory controllers according to the invention provide a flexible means of controlling a wide variety of memories.

The control signals 4025 in FIG. 6 include chip-enable (CE*) signals 4030A-4030N, write-enable (WE*) signals 4035A-4035N, read-enable (RE*) signals 4040A-4040N, and byte enable (BE) signals 4045A-4045N. In exemplary embodiments of the invention, each of the chip-enable signals 4030A-4030N, write-enable signals 4035A-4035N, read-enable (RE*) signals 4040A-4040N, and byte-enable (BE) signals 4045A-4045N couples to a respective one of memories 1015A-1015N. One, however, may use one of the chip-enable signals 4030A-4030N, write-enable signals 4035A-4035N, read-enable (RE*) signals 4040A-4040N, and byte-enable (BE) signals 4045A-4045N to control more than one of the memories 1015A-1015N, as desired. Furthermore, where the memories 1015A-1015N constitute read-only memories, one may exclude from control signals 4025 those signals that facilitate write operations (e.g., write-enable signals 4035A-4035N).

Each of the chip-enable signals 4030A-4030N enables an operation (e.g., read or write) with the respective memory 1015A-1015N to which it couples. In other words, activation of a chip-enable signal 4030A-4030N indicates the beginning of a transaction with the respective memory 1015A-1015N. Together with the chip-enable signals 4030A-4030N, the write-enable signals 4035A-4035N and the read-enable (RE*) signals 4040A-4040N enable write and read operations, respectively. Activation of one of the write-enable signals 4035A-4035N indicates that the memory controller 1005 seeks to perform a write operation to the respective memory 1015A-1015N. Similarly, activation of one of the read-enable signals 4040A-4040N signals the commencement of a read operation with the respective memory 1015A-1015N.

The byte-enable (BE) signals 4045A-4045N provide more flexibility when controlling devices that use less than the full data bus-width to accept data in write transactions. Those devices may accept the data in smaller amounts than the full width of the data bus affords. For example, a device may accept write data in bytes in a system that uses a 32-bit data bus. The device uses the byte-enable (BE) signals 4045A-4045N to determine in which signals of the data bus the desired data (e.g., a byte of information) reside, and to accept the data from those signal lines of the data bus. In a sense, the device may use the byte-enable (BE) signals 4050A-4045N to mask the signals on the data bus.

In exemplary embodiments, the byte-enable (BE) signals 4050A-4050N constitute active-low logic signals. Thus, the memory controller activates the byte-enable (BE) signals 4050A-4050N by asserting binary zeros on those signals. Each of the memories 1015A-1015N receives four byte-enable (BE) signals 4050A-4050N from the memory controller 1005. One, however, may use other numbers of byte-enable signals and/or active-high logic signals, as desired.

Exemplary embodiments of the invention activate the byte-enable (BE) signals 4050A-4050N during write transactions. As a result, the memory controller 1005 provides all of the data-bus signals to a selected device. The selected device may accept the desired data from the data bus and ignore the data on the rest of the data-bus signals. One, however, may use the byte-enable (BE) signals 4050A-4050N for read transactions in a similar manner to write transactions, as desired.

In addition to the signals described above, exemplary embodiments of the invention include an external ready (RDY*) signal (not shown in the figures). The external ready signal controls read and write latencies for a selected one of the memories 1015A-1015N. Using the external ready signal allows an external device to assert the CSI read and write latency via the RDY* input. Put another way, the external ready input provides a flexible mechanism for supporting devices with relatively slow or variable access latencies.

When performing a transfer with the external ready enabled, the memory controller 1005 first determines the desired address and control signals. The memory controller 1005 provides the address signals and asserts the control signals to the selected device (e.g., one of the memories 1015A-1015N). The memory controller 1005 continues to drive the address and control signals until the external device is ready to provide or accept data. At that time, the external device asserts the active-low RDY* input. The memory controller 1005 consequently stops driving the address and control signals and completes the transaction.

As noted above, the interface circuitry 4010 in memory controllers 1005 according to the invention use timing parameters to generate signals that effectuate read and/or write operations with CSI devices. The timing parameters allow the user to program the relative timing of the control signals to one another, and/or to address signals, as desired. The timing parameters include two categories: read timing-parameters and write timing-parameters. Table 1 below describes read timing-parameters in exemplary embodiments of the invention:

TABLE 1

| Parameter | Description |
|---|---|
| Address to read chip- | Used to program the number of clock cycles |
| enable (ARCS) | between the assertion of signals on the |
| | address bus and the assertion of the chip- |
| | enable signal for a read operation |
| Read chip-enable pulse- | Used to program the number of clock cycles |
| width (RCPW) | the chip-enable remains asserted for read |
| | operations |
| Address to read-enable | Used to program the number of clock cycles |
| (ARES) | between the assertion of signals on the |
| | address bus and the assertion of the read- |
| | enable signal |
| Read-enable pulse-width | Used to program the number of clock cycles |
| (REPW) | the read-enable signal remains asserted |
| | during read operations |
| Read wait (RWAIT) | Used to program the number of clock cycles |
| | for which the memory controller delays the |
| | initiation of a memory transaction following a |
| | read operation |
| Read burst-wait enable | Used to select whether wait periods occur |
| (BWE) | between every two succeeding beats of a |
| | read transaction or just at the end of the |
| | burst |

The interface circuitry 4010 in memory controllers 1005 according to the invention may also use write-timing parameters to generate control signals that facilitate write operations with one or more of memories 1015A-1015N. Table 2 below describes write timing-parameters in

TABLE 2

| Parameter | Description |
|---|---|
| Address to write chip- | Used to program the number of clock cycles |
| enable (AWCS) | between the assertion of signals on the |
| | address bus and the assertion of the chip- |
| | enable signal for a write operation |
| Write chip-enable pulse- | Used to program the number of clock cycles |
| width (WCPW) | the chip-enable remains asserted for write |
| | operations |
| Address to write-enable | Used to program the number of clock cycles |
| (AWES) | between the assertion of signals on the |
| | address bus and the assertion of the write- |
| | enable signal |
| Write-enable pulse-width | Used to program the number of clock cycles |
| (WEPW) | the write-enable signal remains asserted |
| | during write operations |
| Write wait (WWAIT) | Used to program the number of clock cycles |
| | for which the memory controller delays the |
| | initiation of a memory transaction following a |
| | write operation |

Exemplary embodiments of the invention provide a programmable wait period following CSI read and write transactions. The user may program the wait period via the read wait (RWAIT) and write wait (WWAIT) parameters. For CSI read transactions, the memory controller 1005 uses the wait period as a means of avoiding tri-state collisions on the memory data-bus. The memory controller 1005 does so by delaying the initiation of subsequent memory transactions following the de-assertion of the CSI chip-enable or chip-select signal until the wait period has expired. This feature facilitates interfacing to CSI devices that de-assert the data bus relatively slowly after a read transaction.

In exemplary embodiments, the user can disable the wait period between beats via the read burst-wait enable (BWE) field. When the read burst-wait enable (BWE) has a binary 0 value, the memory controller 1005 asserts the wait period after the final beat of the burst transaction. On the other hand, when the read burst-wait enable (BWE) has a binary 1 value, the memory controller 1005 asserts the wait period after each beat of the burst transaction.

The read burst-wait enable (BWE) feature facilitates transactions with some CSI devices, such as ROM and flash devices. Such devices allow a change in the address signals after each read burst beat without de-asserting the chip-enable or chip-select signal, but nevertheless use a wait period after the final beat in order to avoid a tri-state collision on the data bus. Setting the BWE field to 0 provides high performance by avoiding a wait period after each beat in a burst, and avoids a tri-state collision on the data bus by including a wait period after the final beat.

In addition to the parameters in Tables 1 and 2, exemplary embodiments of memory controllers according to the invention may also implement various other functions. For example, they may use a ready (RDY) field within the programmable registers 4005 to implement the external ready function described above.

As another example, exemplary embodiments of the invention may use a data bus-width (DBW) field within the programmable registers 4005 to implement a variable-width data bus. This function provides memory controllers according to the invention with an additional degree of flexibility. Memories 1015A-1015N may have differing data bus-widths. For example, one of the memories 1015A-1015N may provide or accept data in 8-bit increments, whereas another one of the memories 1015A-1015N may do so in 16-bit increments. The data bus-width (DBW) field allows the user to program the width of the data bus for the memory controller 1005 to accommodate the data bus-width of the respective memory.

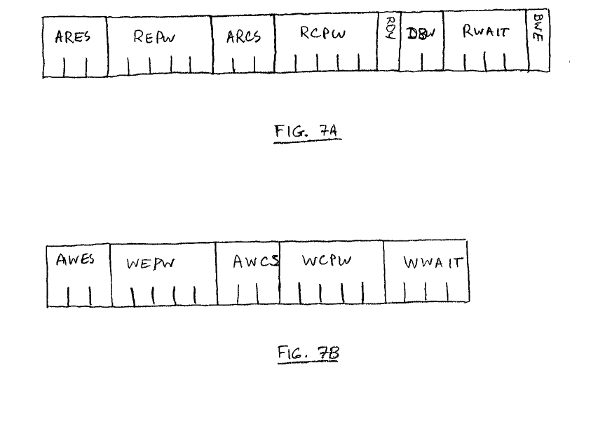

FIG. 7 shows the fields within one of the register sets 5005A-5005N in an exemplary embodiment of the invention. As noted above, each register set 5005A-5005N includes a read timing-parameter register 5005A1-5005N1. Each register set 5005A-5005N may also include a write timing-parameter register 5005A2-5005N2. FIGS. 7A and 7B illustrate one of the read timing-parameter registers 5005A1-5005N1 and one of write timing-parameter registers 5005A2-5005N2, respectively.

The read timing-parameter register in FIG. 7A includes fields for address to read-enable (ARES), read-enable pulse-width (REPW), address to read chip-enable (ARCS), read chip-enable pulse-width (RCPW), read wait (RWAIT), and read burst-wait enable (BWE). These parameters performs the functions described above. Table 3 describes the number of bits in each respective field for those parameters, as well as the respective timing or period that each provides as a number of clock cycles:

TABLE 3

| | No. of Bits in | No. of Clock |
|---|---|---|
| Parameter | Field | Cycles |
| Address to read-enable | 3 | 0-7 |
| (ARES) | | |
| Read-enable pulse-width | 5 | 1-32 |
| (REPW) | | |
| Address to read chip- | 3 | 0-7 |
| enable (ARCS) | | |
| Read chip-enable pulse- | 5 | 1-32 |
| width (RCPW) | | |
| Read wait (RWAIT) | 4 | 0-15 |

The address to read-enable (ARES) parameter occupies a 3-bit field. Consequently, one may program that parameter to cause the assertion of the read-enable signal between 0-7 clock cycles after the assertion of the address signals. A binary value of 000 causes the simultaneous assertion of the read enable and address signals. A binary value of 001 causes the assertion of the read-enable signal one clock cycle after the assertion of the address signals, and so on. The other parameters operate in a similar manner, as persons of ordinary skill in the art who have read the description of the invention would understand.

Note that FIG. 7A also includes fields for the ready (RDY), burst-wait enable (BWE), and data bus-width (DBW) functions. Exemplary embodiments of the invention include those fields as part of the read timing-parameter register, although one may include them in a separate register or as part of another register, as desired.

The ready (RDY) field occupies one bit. A value of 0 disables the external ready function, whereas a value of 1 enables that function. The burst-wait enable (BWE) field also occupies one bit. A value of 0 disables waiting between burst read operations, whereas a value of 1 enables it. The burst-wait enable (BWE) bit has a default value of 0. The data bus-width (DBW) field occupies two bits. Table 4 below describes correspondence between the bit values of the data bus-width (DBW) field and the resulting data-bus widths in one embodiment of the invention:

TABLE 4

| DBW Field Bit Values | Resulting Data-Bus Width |
|---|---|
| 00 | 8 bits |
| 01 | 16 bits |
| 10 | 32 bits |
| 11 | 64 bits |

Similarly, the write timing-parameter register in FIG. 7B includes fields for address to write-enable (AWES), write-enable pulse-width (WEPW), address to write chip-enable (AWCS), write chip-enable pulse-width (WCPW), and write wait (WWAIT). These parameters performs the functions described above. Table 5 describes the number of bits in each respective field for those parameters, as well as the respective timing or period that each provides as a number of clock cycles:

TABLE 5

| | No. of Bits in | No. of Clock |
|---|---|---|
| Parameter | Field | Cycles |
| Address to write-enable | 3 | 0-7 |
| (AWES) | | |
| Write-enable pulse-width | 5 | 1-32 |
| (WEPW) | | |
| Address to write chip- | 3 | 0-7 |
| enable (AWCS) | | |
| Write chip-enable pulse- | 5 | 1-32 |
| width (WCPW) | | |
| Write wait (WWAIT) | 4 | 0-15 |

The address to write-enable (AWES) parameter occupies a 3-bit field. Consequently, one may program that parameter to cause the assertion of the write-enable signal between 0-7 clock cycles after the assertion of the address signals. A binary value of 000 causes the simultaneous assertion of the write enable and address signals. A binary value of 001 causes the assertion of the write-enable signal one clock cycle after the assertion of the address signals, and so on. The other parameters operate in a similar manner, as persons of ordinary skill in the art who have read the description of the invention would understand.

Note that, rather than using the number of bits within each of the fields in the read and write timing-parameter registers described above, one may use other number of bits, as desired. Furthermore, one may include some, rather than all, of the fields described above, depending on design and performance specifications for a particular implementation. Thus, memory controllers according to the invention can provide many relative timing permutations among various signals and therefore control a wide variety of memories.

One may also assign and/or interpret the bit patterns and values differently than described above, as persons of ordinary skill in the art would understand. For example, one may interpret a binary value of 00 within the data bus-width (DBW) field as denoting a 32-bit data bus-width, rather than an 8-bit bus-width. Likewise, one may interpret a binary value of 10 in that field as denoting an 8-bit data bus-width, rather than a 32-bit bus-width, and so on.

Moreover, one may extend the number of bits and/or their corresponding functionality, as desired. For example, one may assign a 64-bit bus-width to bit pattern 11 in the data bus-width (DBW) field, or provide additional bits to support other bus-widths. One may likewise modify the number of bits for other fields to accommodate a variety of memories and systems. Those and other considerations and choices depend on the design and specifications for a particular embodiment. One may readily modify the embodiments described above to accommodate a wide variety of specifications, as persons of ordinary skill in the art who have read the description of the invention would understand.

One may implement the circuitry within the memory controller 1005 in a variety of ways. In exemplary embodiments of the invention, the memory controller 1005 includes finite state machines, counters, and glue logic circuitry (used, for example, in the interface circuitry 4010) that implement control circuitry for the memory controller 1005. One, however, may implement other embodiments of the invention using a wide variety of hardware, as persons of ordinary skill in the art would understand.

The finite state machines control the assertion of the various signals, such as the address signals, the chip-enable signals, etc. The counters, together with the programmable registers 4005 provide a mechanism for programmable relative timing relationships among the control signals 4025 and address signals. Exemplary embodiments of the invention include three counters, implemented as count-down counters. The counters load on specific input event(s), for example, a change of state in a finite state machine. The counters then count a number of clock cycles, specified by the bit values for a respective parameter. Upon reaching the count-down value, the counters trigger an output event, for example, by causing a change of state in a finite state machine. The memory controller 1005 re-uses counters where possible to implement counting for multiple events. Note, however, that one may use a variety of implementations, as desired. For example, one may use counters that count up, rather than down. Also, one may use separate counters for each task, rather than re-use counters, and the like.

In exemplary embodiments, a first counter implements the timing periods for the address to read chip-enable (ARCS), address to write chip-enable (AWCS), read chip-enable pulse-width (RCPW), write chip-enable pulse-width (WCPW), read wait (RWAIT), and write wait (WWAIT) parameters. A second counter implements the timing periods for the address to read-enable (ARES), address to write-enable (AWES), read-enable pulse-width (REPW), and write-enable pulse-width (WEPW) parameters. A third counter counts the number of beats remaining in a requested CSI transfer. At the start of the CSI transfer, the third counter loads with an appropriate value for the requested number of beats. When the third counter reaches its countdown value, the CSI transfer completes.

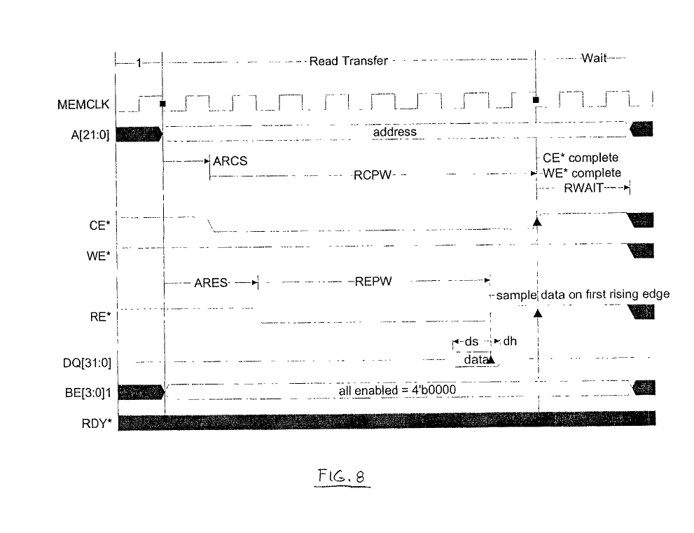

FIGS. 8-13 illustrate exemplary timing diagrams for various transactions with CSI devices. The figures show how the various timing parameters (e.g., ARCS, RCPW, etc.) correspond to particular relative timing of the address and control signals. In the figures, the signal labeled “MEMCLK” corresponds to a clock signal for memory transactions. The signals labeled “A” denote the address bus. For example, “A[21:0]” denotes bits 0 through 21 of a 22 bit address bus, which correspond to a 4-gigabyte address space. Note that although some of the signals in the figure denote particular widths (for example, a 22-bit address bus), one may use other widths, as desired. Signals names within parentheses denote the contents of the referenced signal (e.g., “(A)” refers to the contents of “A”).

FIG. 8 shows an exemplary timing for a single beat read transaction. Note that the memory controller 1005 activates the read-enable (RE*) and chip-enable (CE*) signals during the read transfer phase. The read wait (RWAIT) period begins after the read-enable (RE*) and chip-enable (CE*) signals have become inactive, i.e., during the wait phase. Read data becomes available from the CSI device at the conclusion of the read transfer phase. CSI burst read transactions have a timing similar to back-to-back single-beat CSI read transactions.

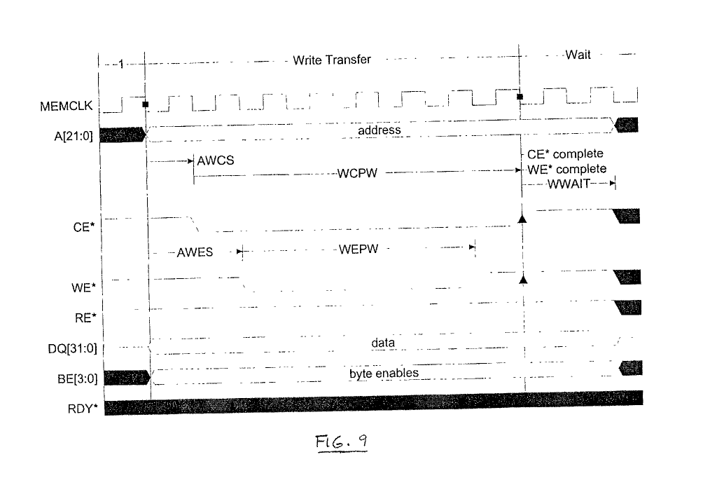

FIG. 9 depicts an exemplary timing for a CSI single-beat write transaction. Note that the memory controller 1005 activates the write-enable (WE*) and chip-enable (CE*) signals during the write transfer phase. The write wait (WWAIT) period begins after the write-enable (WE*) and chip-enable (CE*) signals have become inactive, i.e., during the wait phase. CSI burst write transactions have a timing similar to back-to-back single-beat CSI write transactions.

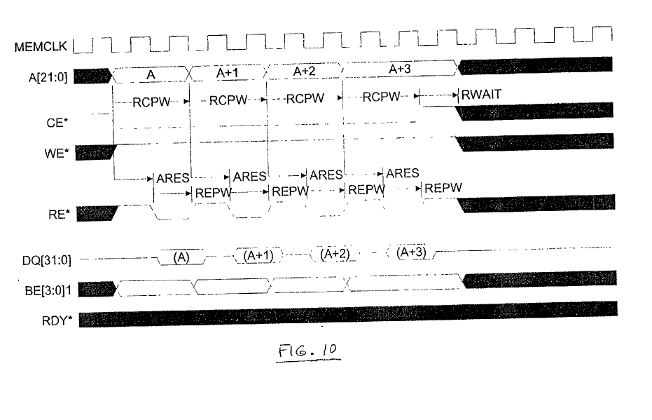

FIG. 10 illustrates an exemplary timing for a 4-beat CSI burst read transaction, with read burst-wait disabled (BWE=0). Note that the chip-enable signal (CE*) remains active during the strobing of the address signals. The read-enable signal (RE*), however, pulses in order to retrieve the four desired beats. Note that, in FIG. 10, RCPW=2, ARCS=0, REPW=1, ARES=1, RWAIT=1, and BWE=0.

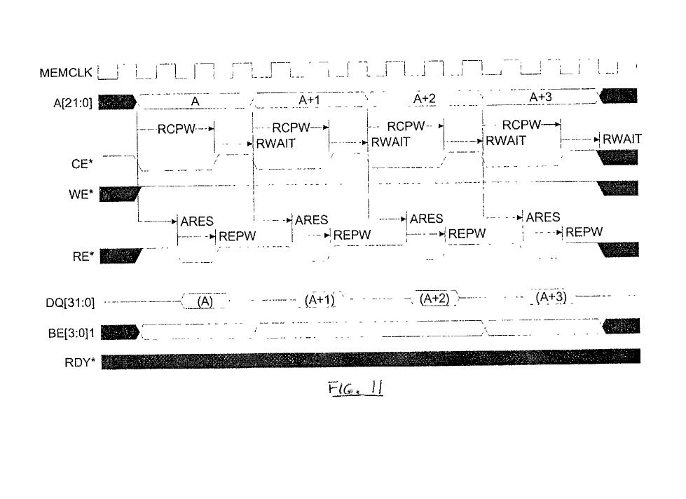

FIG. 11 shows an exemplary timing for a 4-beat CSI burst read transaction, with read burst-wait enabled (BWE=1). Note that, unlike FIG. 10, in FIG. 11, the chip-enable signal (CE*) pulses in order to retrieve the four beats. Similar to FIG. 10, the read-enable signal (RE*) also pulses. A wait period determined by RWAIT follows each activation of the chip-enable (CE*) signal. Note that, in FIG. 11, RCPW=2, ARCS=0, REPW=1, ARES=1, RWAIT=1, and BWE=1.

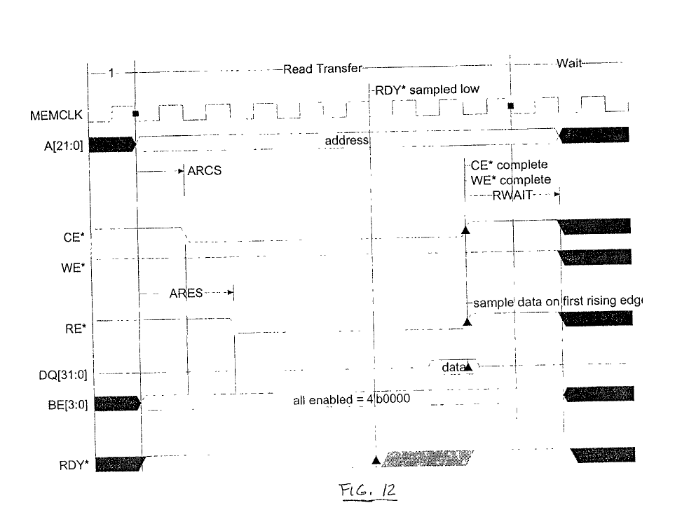

FIG. 12 depicts an exemplary timing for a read transaction where an external device determines the read access latency via the external ready (RDY*) signal. The external device asserts the external ready (RDY*) signal following the assertion of the address signals, the chip-enable (CE*) signal, and the read-enable (RE*) signal. At the next active clock edge, the memory controller samples the RDY* signal, which determines the access latency. Put another way, the memory controller makes the address and control signals available to the external device. The external device uses those signals to perform the requested transaction (e.g., a read transaction). When the external device has finished the external transaction, it signals the end of the transaction to the memory controller by activating the RDY* signal. FIG. 12 assumes that RDY field in the read timing-parameter register has a binary 1 value, thus enabling the setting of access latency via the external ready signal.

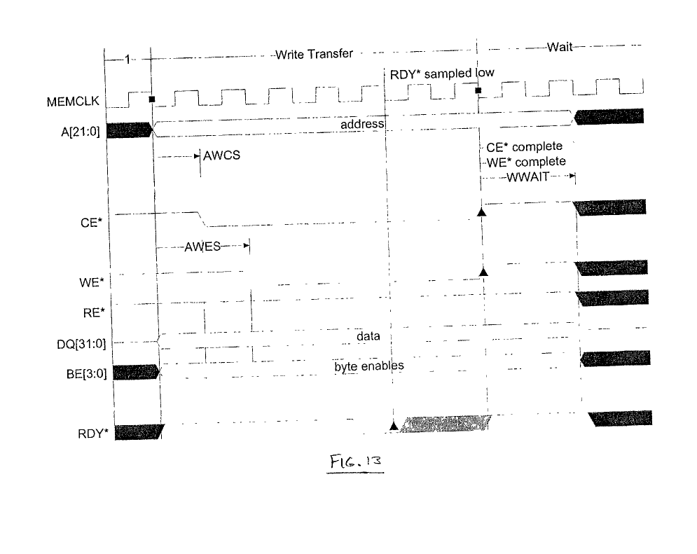

FIG. 13 illustrates an exemplary timing for a write transaction where an external device determines the write access latency via the external ready (RDY*) signal. Following the assertion of the address signals, the chip-enable (CE*) signal, and the write-enable (WE*) signal, the external device asserts the external ready (RDY*) signal. At the next active clock edge, the memory controller samples the RDY* signal, which determines the access latency. Similar to FIG. 13, the memory controller makes the address and control signals available to the external device. The external device uses those signals to perform the requested transaction. When the external device has finished the external transaction (e.g., a write transaction), it signals the end of the transaction to the memory controller by activating the RDY* signal.

Note that FIG. 13 assumes that the user has enabled the external-ready function by programming that function appropriately. In exemplary embodiments, the user may write a binary 1 value to the RDY field in the read timing-parameter register, thus enabling the setting of access latency via the external ready signal. In exemplary embodiments, the RDY field in the read timing-parameter register (see FIG. 7A) controls the enabling and disabling of the external ready functionality for both read and write transactions. Using the same RDY field for both read and write transactions allows sharing hardware, thus saving cost, silicon area, increasing efficiency, etc. One, however, may provide separate RDY fields for read and write transactions for increased flexibility (e.g., individual disabling or enabling for read and write transactions), as desired.

FIGS. 8-13 show timing diagrams for various transaction in exemplary embodiments of the invention. The timing diagrams correspond to particular values of the various read and write timing-parameters. Because of its flexibility, however, one may modify the values of the read and write timing-parameters to support a variety of CSI devices and to implement a broad range of CSI transactions. Thus, the timing diagrams merely provide samples of the operation of memory controllers according to the invention.

Further modifications and alternative embodiments of this invention will be apparent to persons skilled in the art in view of this description of the invention. Accordingly, this description teaches those skilled in the art the manner of carrying out the invention and are to be construed as illustrative only.

The forms of the invention shown and described should be taken as the presently preferred embodiments. Persons skilled in the art may make various changes in the shape, size and arrangement of parts without departing from the scope of the invention described in this document. For example, persons skilled in the art may substitute equivalent elements for the elements illustrated and described here. Moreover, persons skilled in the art who have the benefit of this description of the invention may use certain features of the invention independently of the use of other features, without departing from the scope of the invention.

I claim:

1. A memory controller, comprising:
a register, the register configured to store read timing-parameters for a memory; and
an interface circuitry, the interface circuitry configured to communicate with the memory by providing a plurality of control signals to the memory, the interface circuitry further configured to use the read timing-parameters to provide the plurality of control signals,
wherein relative timing of the plurality of control signals to one another depends at least in part on the read timing-parameters.

2. The memory controller of claim 1, wherein the interface circuitry is further configured to provide a set of address signals to the memory, and wherein relative timing of the plurality of control signals to the set of address signals depends at least in part on the read timing-parameters.

3. The memory controller of claim 2, wherein the read-timing parameters comprise an address-to-read-enable parameter.

4. The memory controller of claim 3, wherein the read-timing parameters further comprise an address-to-chip-enable parameter.

5. The memory controller of claim 4, wherein the read-timing parameters further comprise a read-enable pulse-width parameter.

6. The memory controller of claim 5, wherein the read-timing parameters further comprise a chip-enable pulse-width parameter.

7. The memory controller of claim 6, wherein the read-timing parameters further comprise an address hold parameter.

8. The memory controller of claim 7, wherein the memory is selected from a group consisting of:
read-only memories,
flash memories,
programmable read-only memories,
erasable programmable read-only memories,
electrically erasable read-only memories, and
electrically erasable programmable read-only memories.

9. A memory controller, comprising:
a plurality of register sets, each register set configured to store read timing-parameters and write timing-parameters for interfacing with one of a plurality of memory types; and
an interface circuitry, the interface circuitry configured to communicate with the plurality of memory types by providing a plurality of control signals, the interface circuitry further configured to use the read and write timing parameters to provide the plurality of control signals,
wherein relative timing of the plurality of control signals to one another depends at least in part on the read and write timing-parameters.

10. The memory controller of claim 9, wherein the interface circuitry is further configured to provide a set of address signals to the plurality of memory types, and wherein relative timing of the plurality of control signals to the set of address signals depends at least in part on the read and write timing-parameters.

11. The memory controller of claim 10, wherein each register set further comprises a first programmable register configured to store read-timing parameters for a respective one of the plurality of memory types.

12. The memory controller of claim 11, wherein each register set further comprises a second programmable register configured to store write-timing parameters for a respective one of the plurality of memory types.

13. The memory controller of claim 12, wherein the read-timing parameters comprise an address-to-read-enable parameter.

14. The memory controller of claim 13, wherein the read-timing parameters further comprise a read address-to-chip-enable parameter.

15. The memory controller of claim 14, wherein the read-timing parameters further comprise a read-enable pulse-width parameter.

16. The memory controller of claim 15, wherein the read-timing parameters further comprise a read chip-enable pulse-width parameter.

17. The memory controller of claim 16, wherein the read-timing parameters further comprise a read address hold parameter.

18. The memory controller of claim 17, wherein the write-timing parameters comprise an address-to-write-enable parameter.

19. The memory controller of claim 18, wherein the write-timing parameters further comprise a write address-to-chip-enable parameter.

20. The memory controller of claim 19, wherein the write-timing parameters further comprise a write-enable pulse-width parameter.

21. The memory controller of claim 20, wherein the write-timing parameters further comprise a write chip-enable pulse-width parameter.

22. The memory controller of claim 21, wherein the write-timing parameters further comprise a write address hold parameter.

23. The memory controller of claim 22, configured to reside within an integrated circuit.

24. The memory controller of claim 23, wherein each one of the plurality of memory types is selected from a group consisting of:
read-only memories,
flash memories,
programmable read-only memories,
erasable programmable read-only memories,
electrically erasable read-only memories, and
electrically erasable programmable read-only memories.

25. A data-processing system, comprising:
a processor, the processor configured to receive, decode, and execute instructions;
at least one memory, the at least one memory configured to store and retrieve data and instructions; and
a memory controller coupled to the processor and to at least one memory, the memory controller configured to provide communication between the processor and the at least one memory, the memory controller further configured to communicate with the at least one memory by using a plurality of signals,
wherein the plurality of signals have a pre-determined relative timing relationship to one another that depends, at least in part, on a set of configurable parameters.

26. The data-processing system of claim 25, wherein the set of configurable parameters includes a read chip-enable parameter, and a read chip-enable pulse-width parameter.

27. The data-processing system of claim 26, wherein the set of configurable parameters includes a read-enable parameter, and a read-enable pulse-width parameter.

28. The data-processing system of claim 27, wherein the set of configurable parameters includes a write chip-enable parameter, and a write chip-enable pulse-width parameter.

29. The data-processing system of claim 28, wherein the set of configurable parameters includes a write-enable parameter, and a write-enable pulse-width parameter.

30. The data-processing system of claim 29, wherein the set of configurable parameters includes a read wait parameter.

31. The data-processing system of claim 30, wherein the set of configurable parameters includes a write wait parameter.

32. The data-processing system of claim 31, wherein the set of configurable parameters includes a read burst-wait-enable parameter.

33. The data-processing system of claim 32, wherein the set of configurable parameters includes a data bus-width parameter that selects a data bus-width of the at least one memory.

34. The data-processing system of claim 32, wherein the set of configurable parameters includes a ready parameter used to enable an external ready input, and wherein the external ready input determines access latency of the at least one memory.

35. The data-processing system of claim 34, configured to control a plurality of memories, the data-processing system further comprising separate sets of configurable parameters for each of the plurality of memories.

36. The data-processing system of claim 35, configured to reside within an integrated circuit.

37. The memory controller of claim 36, wherein each of the plurality of memories is selected from a group consisting of:
read-only memories,
flash memories,
programmable read-only memories,
erasable programmable read-only memories,
electrically erasable read-only memories, and
electrically erasable programmable read-only memories.

38. A method of interfacing with a memory, comprising:
storing in a register read timing-parameters for the memory;
using the read timing-parameters to provide a plurality of signals; and
communicating the plurality of signals to the memory,
wherein relative timing of the plurality of signals to one another depends at least in part on the read timing-parameters.

39. The method of claim 38, wherein using the read timing-parameters to provide the plurality of signals further comprises using an address-to-read-enable parameter.

40. The method of claim 39, wherein using the read timing-parameters to provide the plurality of signals further comprises using an address-to-chip-enable parameter.

41. The method of claim 40, wherein using the read timing-parameters to provide the plurality of signals further comprises using a read-enable pulse-width parameter.

42. The method of claim 41, wherein using the read timing-parameters to provide the plurality of signals further comprises using a chip-enable pulse-width parameter.

43. The method of claim 42, wherein using the read timing-parameters to provide the plurality of signals further comprises using an address hold parameter.

44. The method of claim 43, which further comprises selecting the memory from a group consisting of:
read-only memories,
flash memories,
programmable read-only memories,
erasable programmable read-only memories,
electrically erasable read-only memories, and
electrically erasable programmable read-only memories.

45. A method of communicating with a plurality of memory types, comprising:
storing in each of a plurality of register sets read timing-parameters and write timing-parameters for a selected one of the plurality of memory types;
using the read and write timing-parameters for a selected one of the plurality of memory types to provide a plurality of signals; and
communicating the plurality of signals to the selected one of the plurality of memory types,
wherein relative timing of the plurality of signals to one another depends at least in part on the read and write timing-parameters.

46. The method of claim 45, wherein using the read and write timing-parameters further comprises using an address-to-read-enable parameter.

47. The method of claim 46, wherein using the read and write timing-parameters further comprises using a read address-to-chip-enable parameter.

48. The method of claim 47, wherein using the read and write timing-parameters further comprises using a read-enable pulse-width parameter.

49. The method of claim 48, wherein using the read and write timing-parameters further comprises using a read chip-enable pulse-width parameter.

50. The method of claim 49, wherein using the read and write timing-parameters further comprises using a read address hold parameter.

51. The method of claim 50, wherein using the read and write timing-parameters further comprises using an address-to-write-enable parameter.

52. The method of claim 51, wherein using the read and write timing-parameters further comprises using a write address-to-chip-enable parameter.

53. The method of claim 52, wherein using the read and write timing-parameters further comprises using a write-enable pulse-width parameter.

54. The method of claim 53, wherein using the read and write timing-parameters further comprises using a write chip-enable pulse-width parameter.

55. The method of claim 54, wherein using the read and write timing-parameters further comprises using a write address hold parameter.
